(19) United States
(12) Patent Application Publication
(10) Pub. No.: US 2008/0251362 A1
(43) Pub. Date: Oct. 16, 2008

(54) Contact Holder

(75) Inventors: Werner Puri, Nurnberg (DE); Joachim Seidl, Sulzbach-Rosenberg (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, Munich (DE)

(21) Appl. No.: 11/597,295

(22) PCT Filed: May 18, 2005
(86) PCT No.: PCT/EP05/52294

§ 371 Date: Feb. 6, 2008

(30) Foreign Application Priority Data
May 26, 2004 (EP) 04012445.5

(51) Int. Cl. H01H 9/00

(52) U.S. Cl. 200/245

(57) ABSTRACT

A contact holder is disclosed for a contact system. An embodiment of the contact holder permits a particularly secure contacting with a particularly simple construction. The above is achieved by way of a function integration of spring and support for the moving contact of the contact system in a single component.

### PRIORITY STATEMENT

This application is the national phase under 35 U.S.C. §371 of PCT International Application No. PCT/EP2005/052294 which has an International filing date of May 18, 2005, which designated the United States of America and which claims priority on European Patent Application number EP 04012445 filed May 26, 2004, the entire contents of which are hereby incorporated herein by reference.

### FIELD

The invention generally relates to a contact holder for a contact system. For example, the invention may relate to a contact holder for a contact system of an electromechanical switching device, for example a contactor, position switch, command and signaling device or a contactor combination.

### BACKGROUND

A contact system has both a fixed contact and a moveable contact. The fixed contact in this case serves the purpose of making contact with a connection line or the like. The moveable contact serves the purpose of opening and closing the contact system. For this purpose, the moveable contact needs to be mounted such that the switching pieces of the moveable and the fixed contact meet one another in a defined manner.

In order to make secure contact, it is also necessary for a defined contact-making force to be applied. In addition, the moveable contact should be largely decoupled from its drive or actuation element, for example a solenoid drive, slide, switching piece carrier, snap-action system or the like, in order to avoid negative kinetic influences.

For this purpose, it is known from the prior art to mount the moveable contact via a metal spring, which acts on the moveable contact directly or indirectly, for example via a moveable contact holder or a snap-action system. This metal spring not only results in shortening of the air gaps and leakage paths but also, as an additional component, entails higher costs in terms of materials and fitting and increases the risk of faults in the entire assembly.

U.S. Pat. No. 4,405,848 has disclosed an electrical contact apparatus which ensures contact-making between fixed and moveable contacts, the elastic elements being produced from plastic. The elastic elements are used for increasing the contact pressure and therefore for increasing the voltage stability.

### SUMMARY

At least one embodiment of the invention is directed to a contact holder that makes possible to make particularly secure contact with a particularly simple design.

Accordingly, the contact holder, in at least one embodiment, has both at least one receiving region and a sprung region. In this case, the receiving region serves the purpose of receiving the moveable contact, i.e. producing a mechanical connection with the moveable contact, while the sprung region serves the purpose of actuating the moveable contact and at the same time of mounting the moveable contact in a sprung manner. The contact holder can be used in a contact system which has a fixed contact, in particular for making contact with a connection line, and a moveable contact, which can be actuated by a drive or actuation element, for opening and closing the electrical connection with the fixed contact.

A basic concept of at least one embodiment of the invention is to provide for functional integration of resilience and mounting for the moveable contact via a single component. The use of an additional metal spring or the like can therefore be dispensed with. Owing to the functional integration, a considerable reduction in the number of components is achieved. This leads to lower costs in terms of materials and fitting and also reduces the risk of faults in the assembly.

The number of degrees of freedom of the mounting point between the spring and the moveable contact link in the case of direct mounting or between the spring and the moveable contact holder or the snap-action system in the case of indirect mounting is reduced. Erroneous positioning of the moveable contact or the spring is therefore avoided and the possibility of the function being impaired is counteracted.

The contact holder, in at least one embodiment, expediently exclusively includes the at least one receiving region and the sprung region. With the aid of these two functional regions, all the necessary tasks of the contact holder can be managed. Further additional elements are not required. This results in a particularly simple and compact design. The sprung region of the contact holder can in this case assume different geometrical shapes depending on the requirements of the intended use, simple spring shapes having proven particularly successful in practice.

If the sprung region of the contact holder has a connecting element for producing a mechanical connection with a further contact holder, the contact holder can be used in a particularly varied manner in the widest variety of contact systems.

In one example embodiment of the invention, the contact holder is produced from an electrically nonconducting material. Air gaps and leakage paths are not shortened by electrically nonconducting components, as a result of which a considerable reduction in the required amount of physical space is possible. The material is preferably a thermoplastic (such as, for example PES, PESU, PEI, PPS, POM, PA) or an elastomer. The unfavorable post-oscillation of the movable contact is reduced in comparison with the use of a metal spring since such materials have a greater damping constant than metal.

In particular when using an integral contact holder, negative influences on the mechanical connection of the sprung region and the receiving region can be ruled out since these have the same coefficient of thermal expansion. The use of plastics such as thermoplastics or elastomers at the same time allows for integration of functional areas on the contact holder. As a result, the assembly can have an optimized design in terms of fitting, for example have guide areas and mounting areas. This reduces costs in terms of development, materials and fitting.

### BRIEF DESCRIPTION OF THE DRAWINGS

The present invention will be described in more detail below with reference to example embodiments, which will be explained with the aid of the drawings, in which:

FIG. 1 shows a schematic illustration of a contact system in accordance with the prior art,

FIGS. 2 to 4 show embodiments of the invention with annular sprung regions and two receiving regions,

FIGS. 5 to 7 show embodiments of the invention with annular sprung regions and a receiving region,

FIGS. 8 and 9 show an embodiment of the invention with a spherical sprung region,

FIG. 10 shows an embodiment of the invention with a meandering sprung region,

FIG. 11 shows an embodiment of the invention with a helical sprung region,

FIGS. 12 and 13 show an embodiment of the invention with a bent sprung region,

FIG. 14 shows an embodiment of the invention with a two-part sprung region, and

FIG. 15 shows an embodiment of the invention with a connecting element.

### DETAILED DESCRIPTION OF THE EXAMPLE EMBODIMENTS

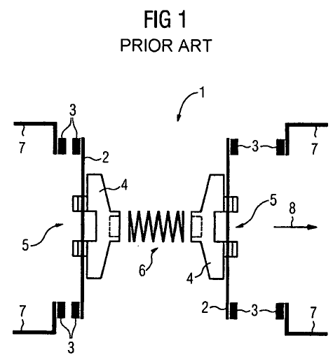

A known contact system 1 in accordance with the prior art is shown in FIG. 1. The moveable contact 2 with its two switching pieces 3 fitted at the end is in this case fitted to a contact holder 4. This contact holder 4 has a receiving region 5 for the moveable contact 2.

The contact holder 4 is mounted via a metal spring 6, which, as a link spring, at the same time produces the connection to the opposite contact system 2, which has the same design. When the contact is actuated by a drive or actuation element (not depicted), the moveable contact 2 is moved towards a fixed contact 7 in the contact-making direction 8, the switching pieces 3 of the moveable contact 2 and of the fixed contact 7 meeting one another in a defined manner.

FIGS. 2, 3 and 4 show embodiments of the contact holder 10 according to an embodiment of the invention in a plan view showing how they can be used in contact systems having two links. These contact holders 10 have two receiving regions 11, which are arranged symmetrically with respect to one another, for receiving in each case one moveable contact (not depicted). Each receiving region 11 in this case includes two receiving element pairs, which are integrally formed on opposite sides of a sprung region 12. Each receiving element pair has two receiving elements 14, which are spaced apart from one another and extend in the connecting direction 13.

In order to produce a mechanical connection between the moveable contact and the contact holder 10, a snap-action or latching hook 15 is provided on each receiving element 14. When the moveable contact is mounted on the contact holder 10, the moveable contact is pushed onto the two snap-action hooks 15 of the respective receiving element pair with its correspondingly provided snap-action cutouts.

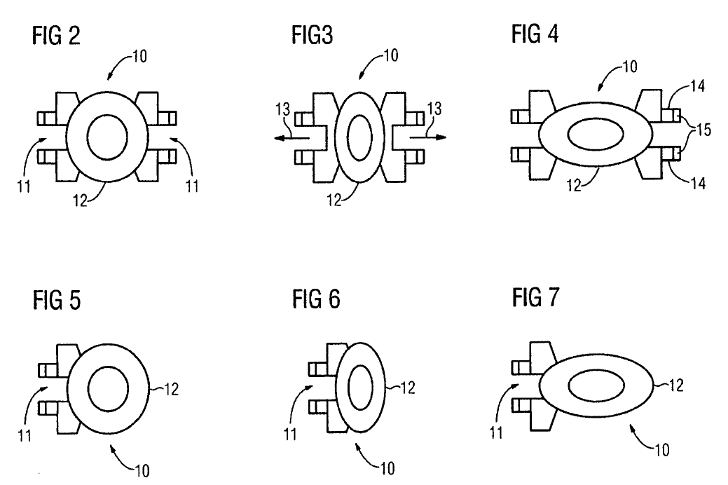

The two receiving regions 11 are connected to one another by the sprung region 12. In FIG. 2, the sprung region 12 has the shape of an annular disk, the spring action primarily being provided by the design of the contours of said disk. The resultant contact holder 10 is on the one hand robust enough to receive, mount and fix a moveable contact. On the other hand, the flexible, sprung and damping region is designed such that it can replace the previous additional contact spring. Instead of a circular sprung region, regions 12 having a stretched or compressed oval cross section can also be used, cf. FIG. 3 and FIG. 4.

FIGS. 5, 6 and 7 represent embodiments of the contact holder 10 having a circular or stretched and compressed oval sprung region 12 showing how they can be used, for example, in a contact system having a carrier, in the case of which the slide or driver which can be actuated from the outside is used as a tie between, for example, an external pushbutton or the like and the actual switching element, i.e. the moveable contact. In this case, the contact holders 10 each have only a single receiving region 11 for receiving a moveable contact. The configuration of the receiving region 11 with a receiving element pair 14 in this case corresponds to the embodiment already shown in FIG. 2.

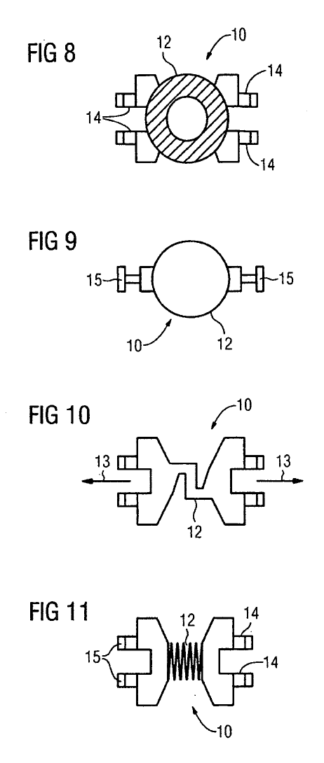

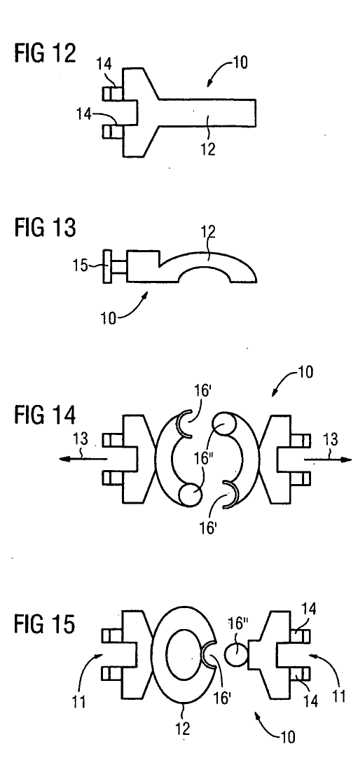

FIGS. 8 and 9 show a further embodiment of a contact holder 10, in which the sprung region 12 is in the form of a hollow sphere. In this case, FIG. 8 illustrates a view with a partially cut-open sprung region 12, while FIG. 9 depicts a plan view. Instead of a hollow sphere, a solid sphere can also be used. In FIGS. 10 and 11, contact holders 10 are depicted with meandering or helical sprung regions 12. A contact holder 10 with a sprung region 12 which is bent in the form of a tongue is shown in FIGS. 12 and 13. In this case, FIG. 12 depicts the contact holder 10 illustrated in a plan view, and FIG. 13 depicts the contact holder 10 illustrated in a side view.

Particularly advantageous are embodiments in which the contact holder 10, in particular the sprung region 12 of the contact holder 10, has a connecting element. Such contact holders 10 can be used in a particularly varied manner both in contact systems having links on both sides and in carrier contact systems having contacts on one side. FIG. 14 shows an embodiment in which the sprung region 12 is split up with the aid of two connecting elements 16 so as to produce two contact holders 10 which are symmetrical with respect to one another and each have a semicircular sprung region 12.

The connecting elements 16′, 16″ are in this case expediently designed to form a snap-action or latching connection. FIG. 15 illustrates a further embodiment in which a single connecting element 16′ is arranged on a circular sprung region 12 such that a corresponding mating connecting element 16″ can be used which is formed directly on a contact holder 10 having a sprung region 12 in the form of a tongue.

Embodiments of the present invention can be used for any desired types of contact systems, in particular for contact systems having a link spring or the like for applying a contact force in a defined manner. This relates both to contact systems having a snap-action or slow make-and-break system, in particular position switches, and solenoid-operated contact systems, in particular contactors.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A contact holder for a contact system, comprising:
a fixed contacts;
a moveable contact for producing an electrical connection with the fixed contact; and
at least one receiving region for receiving the moveable contact and a sprung region, connected integrally with the receiving region, for actuating the moveable contact via at least one of a drive element and an actuation element.

2. The contact holder as claimed in claim 1, wherein the contact holder includes functional integration of resilience and mounting for the moveable contact.

3. The contact holder as claimed in claim 1, wherein the contact holder exclusively comprises the at least one receiving region and the sprung region.

4. The contact holder as claimed in claim 1, further comprising:
a connecting element for producing a mechanical connection with a further contact holder.

5. The contact holder as claimed in claim 1, wherein the contact holder is made of an electrically non-conducting material.

6. A contact system, comprising:
a contact holder;
a fixed contact;
a moveable contact for producing an electrical connection with the fixed contact, and
at least one of a drive element and an actuation element for actuating the moveable contact; and
a contact holder including at least one receiving region for receiving the moveable contact and a sprung region, connected integrally with the receiving region, for actuating the moveable contact via the at least one of a drive element and an actuation element.

7. A method, comprising:
using the contact holder as claimed in claim 1 in a contact system.

8. The contact holder as claimed in claim 2, wherein the contact holder exclusively comprises the at least one receiving region and the sprung region.

9. The contact holder as claimed in claim 2, further comprising:
a connecting element for producing a mechanical connection with a further contact holder.

10. The contact holder as claimed in claim 3, further comprising:
a connecting element for producing a mechanical connection with a further contact holder.

11. The contact holder as claimed in claim 8, further comprising:
a connecting element for producing a mechanical connection with a further contact holder.

12. The contact holder as claimed in claim 1, wherein the contact holder is produced made of at least one of thermoplastic and an elastomer.

13. A contact holder for a contact system, comprising:
at least one receiving region to receive a moveable contact of the contact system and a sprung region, connected integrally with the receiving region, to actuate the moveable contact via at least one of a drive element and an actuation element of the contact system.

14. The contact holder as claimed in claim 13, wherein the contact holder includes functional integration of resilience and mounting for the moveable contact.

15. The contact holder as claimed in claim 13, further comprising:
a connecting element for producing a mechanical connection with a further contact holder.

16. The contact holder as claimed in claim 13, wherein the contact holder is made of an electrically non-conducting material.

17. A contact system, comprising:
a fixed contact;
a moveable contact to produce an electrical connection with the fixed contact; and
at least one of a drive element and an actuation element to actuate the moveable contact; and
a contact holder as claimed in claim 13.
